(19) United States
(12) Patent Application Publication
(10) Pub. No.: US 2020/0317219 A1
(43) Pub. Date: Oct. 8, 2020

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Mineyuki Yoshida, Wako-shi (JP); Yoshihiro Oniwa, Wako-shi (JP); Hiroshi Oguro, Wako-shi (JP)

(21) Appl. No.: 16/305,106

(22) PCT Filed: May 12, 2017
(86) PCT No.: PCT/JP2017/018019

§ 371 Date: Nov. 28, 2018

(30) Foreign Application Priority Data
May 31, 2016 (JP) 2016-108527

(51) Int. Cl. B60W 60/00; B60W 40/10; B60W 10/20

(52) U.S. Cl. CPC B60W 60/001; B60W 40/10; B60W 2720/24; B60W 2554/4041; B60W 2520/06; B60W 10/20

(57) ABSTRACT

A vehicle control system includes: a position recognizing unit recognizing a position of a vehicle; a locus generating unit generating a target locus of the vehicle; and a running control unit setting a reference position with respect to the position of the vehicle recognized by the position recognizing unit on the target locus generated by the locus generating unit and controlling steering of the vehicle on the basis of a circular arc that has a tangent along an travelling direction of the vehicle and passes through the reference position and the position of the vehicle.

### TECHNICAL FIELD

The present invention relates to a vehicle control system, a vehicle control method, and a vehicle control program.

Priority is claimed on Japanese Patent Application No. 2016-108527, filed on May 31, 2016, the content of which is incorporated herein by reference.

### BACKGROUND ART

Conventionally, devices determining a steering angle of a subject vehicle on the basis of a running locus of a preceding vehicle are known (for example, Patent Literature 1). This following system sets a point at which a perpendicular line extending from a position of a subject vehicle toward a running locus of a preceding vehicle and the running locus of the preceding vehicle intersect with each other. In addition, the following system calculates a predicted position reached when the subject vehicle runs from the perpendicular point at the current speed of the subject vehicle for a predetermined time and performs steering control on the basis of a radius of curvature of the running locus of the preceding vehicle at the predicted position.

### CITATION LIST

### Patent Literature

[Patent Literature 1]

Japanese Unexamined Patent Application, First Publication No. H10-100738

### SUMMARY OF INVENTION

### Technical Problem

In a case in which the running locus of the preceding vehicle at the predicted position is a running locus having a small radius of curvature to form a sharp curve, there are cases in which the steering angle of the subject vehicle greatly changes.

An aspect according to the present invention has been made in consideration of such situations, and one object thereof is to provide a vehicle control system, a vehicle control method, and a vehicle control program capable of realizing smoother steering control.

### Solution to Problem

(1) According to one aspect of the present invention, there is provided a vehicle control system including: a position recognizing unit configured to recognize a position of a vehicle; a locus generating unit configured to generate a target locus of the vehicle; and a running control unit configured to set a reference position with respect to the position of the vehicle recognized by the position recognizing unit on the target locus generated by the locus generating unit and control steering of the vehicle on the basis of a circular arc that has a tangent along a travelling direction of the vehicle and passes through the reference position and the position of the vehicle.

(2) In the aspect (1) described above, the running control unit may set a position on the target locus of the vehicle in a case in which the vehicle is assumed to have run on the target locus for a predetermined time or over a predetermined distance from a position on the target locus that is the closest to the position of the vehicle recognized by the position recognizing unit as the reference position.

(3) In the aspect (1) or (2) described above, the running control unit may derive a first index value based on the circular arc and a second index value for increasing control of steering of the vehicle as a deviation between the reference position and the position of the vehicle in a direction orthogonal to the travelling direction of the vehicle becomes larger and control the steering of the vehicle on the basis of the first index value and the second index value.

(4) In the aspect (3) described above, in a case in which the deviation is equal to or greater than a first predetermined value, the running control unit may limit the control of the steering of the vehicle.

(5) In any one of the aspects (1) to (4) described above, in a case in which a curvature of the circular arc exceeds a second predetermined value, the running control unit may limit the control of the steering of the vehicle.

(6) In the aspect (3) described above, the running control unit may control the steering of the vehicle on the basis of a position of the vehicle on the circular arc in a case in which the vehicle runs on the circular arc for a time shorter than the predetermined time used for acquiring the reference position and the position of the vehicle recognized by the position recognizing unit.

(7) According to one aspect of the present invention, there is provided a vehicle control method using an in-vehicle computer, the vehicle control method including: generating a future target locus of the vehicle; and setting a reference position with respect to a position of the vehicle recognized by a position recognizing unit recognizing the position of the vehicle on the generated future target locus and controlling steering of the vehicle on the basis of a circular arc that has a tangent along a travelling direction of the vehicle and passes through the reference position and the position of the vehicle.

(8) According to one aspect of the present invention, there is provided a vehicle control program causing an in-vehicle computer to execute: generating a future target locus of the vehicle; and setting a reference position with respect to a position of the vehicle recognized by a position recognizing unit recognizing the position of the vehicle on the generated future target locus and controlling steering of the vehicle on the basis of a circular arc that has a tangent along a travelling direction of the vehicle and passes through the reference position and the position of the vehicle.

### Advantageous Effects of Invention

According to the aspects (1), (2), and (4) to (8) described above, the steering of a vehicle is controlled on the basis of a circular arc passing through a reference position and a position of the vehicle, and accordingly, smoother steering control can be realized.

According to the aspect (3) described above, the running control unit controls the steering of a vehicle on the basis of a first index value based on a circular arc and a second index value for increasing control of the steering of the vehicle as a deviation between the reference position and the position of the vehicle in a direction orthogonal to the travelling direction of the vehicle becomes larger, whereby steering can be controlled such that the vehicle is closer to the target locus.

### BRIEF DESCRIPTION OF DRAWINGS

FIG. 1 is a diagram illustrating constituent elements of a vehicle in which a vehicle control system according to each embodiment is mounted.

FIG. 2 is functional configuration diagram focusing on a vehicle control system according to a first embodiment.

FIG. 3 is a diagram illustrating a view in which a relative position of a subject vehicle with respect to a running lane is recognized by a subject vehicle position recognizing unit.

FIG. 4 is a diagram illustrating one example of an action plan generated for a certain section.

FIG. 5 is a diagram illustrating one example of the configuration of a locus generating unit.

FIG. 6 is a diagram illustrating one example of candidates for a locus generated by a locus candidate generating unit.

FIG. 7 is a diagram in which candidates for a locus generated by a locus candidate generating unit are represented using locus points K.

FIG. 8 is a diagram illustrating a lane change target position.

FIG. 9 is a diagram illustrating a speed generation model of a case in which the speeds of three surrounding vehicles are assumed to be constant.

FIG. 10 is a diagram illustrating relations between an acceleration/deceleration control unit and a steering angle control unit and control targets thereof.

FIG. 11 is a diagram illustrating one example of the function of a steering angle control unit.

FIG. 12 is a diagram illustrating a steering angle deriving process performed by a first steering angle deriving unit.

FIG. 13 is a conceptual diagram of the deriving of a second steering angle using a second steering angle deriving unit.

FIG. 14 is a flowchart illustrating the flow of a process executed by a steering angle control unit.

FIG. 15 is a diagram illustrating one example of a view in which a gazing position is derived.

FIG. 16 is a diagram illustrating a circular arc derived by the first steering angle deriving unit.

FIG. 17 is a diagram illustrating one example of a view in which a subject vehicle is controlled in a processing period (2).

FIG. 18 is a diagram illustrating one example of a view in which a subject vehicle is controlled in a processing period (3).

FIG. 19 is a diagram illustrating one example of a view in which a subject vehicle is controlled in a processing period (4).

FIG. 20 is a diagram illustrating one example of a view in which a subject vehicle is controlled in a processing period (5).

FIG. 21 is a diagram illustrating one example of a gazing position derived in a case in which a target locus has a predetermined curvature.

FIG. 22 is a diagram illustrating one example of the function of a steering angle control unit according to a second embodiment.

FIG. 23 is a flowchart illustrating the flow of a process executed by the steering angle control unit.

FIG. 24 is a diagram illustrating one example of a steering angle map.

FIG. 25 is a diagram illustrating one example of the functional configuration of a vehicle control system according to a third embodiment.

### DESCRIPTION OF EMBODIMENTS

Hereinafter, a vehicle control system, a vehicle control method, and a vehicle control program according to embodiments of the present invention will be described with reference to the drawings.

### First Embodiment

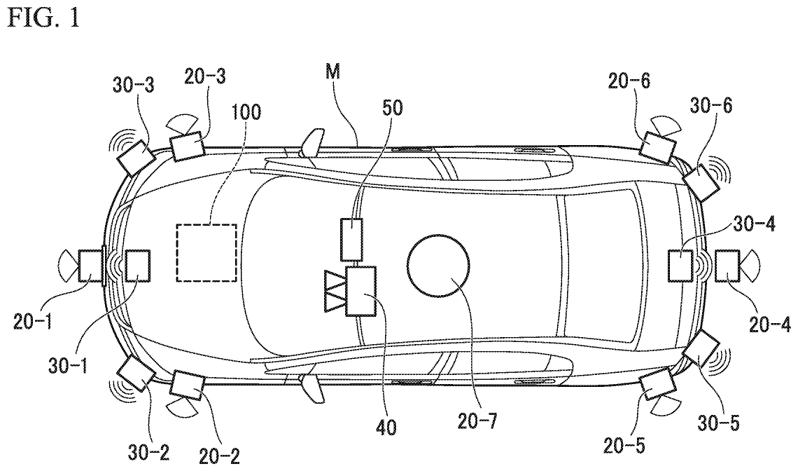

FIG. 1 is a diagram illustrating constituent elements of a vehicle (hereinafter referred to as a subject vehicle M) in which a vehicle control system 100 according to each embodiment is mounted. A vehicle in which the vehicle control system 100 is mounted, for example, is a vehicle with two wheels, three wheels, four wheels, or the like and includes an automobile having an internal combustion engine such as a diesel engine or a gasoline engine as its power source, an electric vehicle having a motor as its power source, a hybrid vehicle equipped with both an internal combustion engine and a motor, and the like. The electric vehicle described above, for example, is driven using electric power discharged by a cell such as a secondary cell, an alcohol fuel cell, a metal fuel cell, an alcohol fuel cell, or the like.

As illustrated in FIG. 1, sensors such as finders 20-1 to 20-7, radars 30-1 to 30-6, a camera 40, and the like, a navigation device 50 (route guiding device), and a vehicle control system 100 are mounted in the subject vehicle M.

Each of the finders 20-1 to 20-7, for example, is a light detection and ranging or a laser imaging detection and ranging (LIDAR) device measuring a distance to a target by measuring scattered light from emitted light. For example, the finder 20-1 is mounted on a front grille or the like, and the finders 20-2 and 20-3 are mounted on side faces of a vehicle body, door mirrors, inside of head lights, on near side lights, or the like. The finder 20-4 is mounted in a trunk lid or the like, and the finders 20-5 and 20-6 are mounted on side faces of the vehicle body, inside of tail lamps or the like. Each of the finders 20-1 to 20-6 described above, for example, has a detection area of about 150 degrees with respect to a horizontal direction. In addition, the finder 20-7 is mounted on a roof or the like.

For example, the finder 20-7 has a detection area of 360 degrees with respect to a horizontal direction. The radars 30-1 and 30-4, for example, are long-distance millimeter wave radars having a wider detection area in a depth direction than that of the other radars. In addition, the radars 30-2, 30-3, 30-5, and 30-6 are middle-distance millimeter wave radars having a narrower detection area in a depth direction than that of the radars 30-1 and 30-4.

Hereinafter, in a case in which the finders 20-1 to 20-7 are not particularly distinguished from each other, one thereof will be simply referred to as a “finder 20,” and, in a case in which the radars 30-1 to 30-6 are not particularly distinguished from each other, one thereof will be simply referred to as a “radar 30.” The radar 30, for example, detects an object using a frequency modulated continuous wave (FM-CW) system.

The camera 40, for example, is a digital camera using a solid-state imaging device such as a charge coupled device (CCD), a complementary metal oxide semiconductor (CMOS), or the like. The camera 40 is mounted in an upper part of a front windshield, a rear face of an interior mirror, or the like. The camera 40, for example, repeats imaging of the side in front of the subject vehicle M periodically. The camera 40 may be a stereo camera including a plurality of cameras.

The configuration illustrated in FIG. 1 is merely one example, and a part of the configuration may be omitted, and other different components may be added.

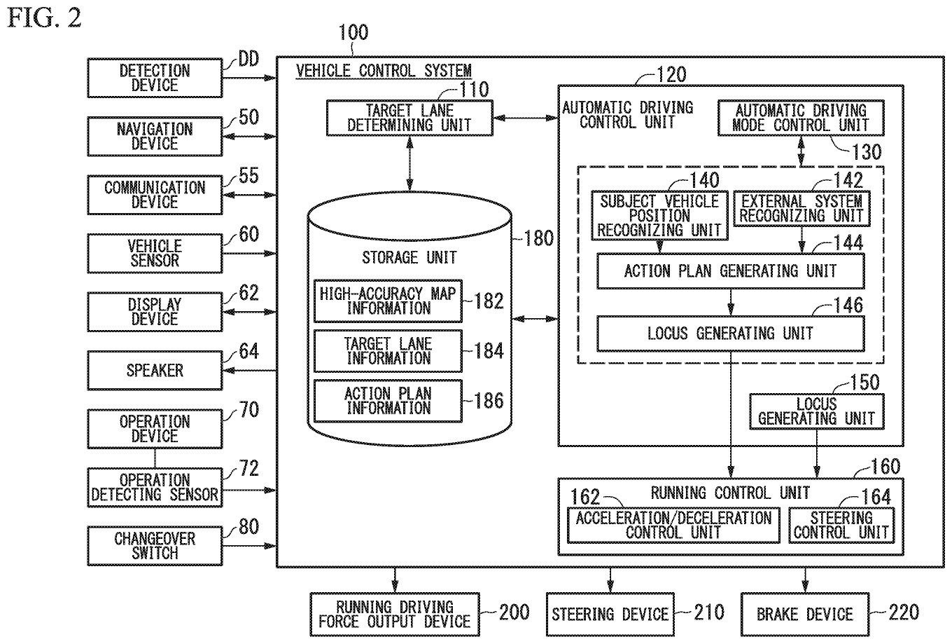

FIG. 2 is functional configuration diagram focusing on a vehicle control system 100 according to a first embodiment. In the subject vehicle M, a detection devices DD including finders 20, radars 30, a camera 40, and the like, a navigation device 50, a communication device 55, a vehicle sensor 60, a display device 62, a speaker 64, a switching unit 66, an operation device 70, an operation detecting sensor 72, a changeover switch 80, a vehicle control system 100, a running driving force output device 200, a steering device 210, and a brake device 220 are mounted. Such devices and units are interconnected through a multiple-communication line such as a controller area network (CAN) communication line, a serial communication line, a radio communication network, or the like. The vehicle control system 100 and the components (the detection device DD and the like) other than the vehicle control system 100 may be referred to as a vehicle control system.

The navigation device 50 includes a global navigation satellite system (GNSS) receiver, map information (navigation map), a touch panel-type display device functioning as a user interface, a speaker, a microphone, and the like. The navigation device 50 identifies a location of the subject vehicle M using the GNSS receiver and derives a route from the location to a destination designated by a user. The route derived by the navigation device 50 is provided to the target lane determining unit 110 of the vehicle control system 100. The location of the subject vehicle M may be identified or complemented by an inertial navigation system (INS) using an output of the vehicle sensor 60. In addition, when the vehicle control system 100 implements a manual driving mode, the navigation device 50 performs guidance using speech or a navigation display for a route to the destination. Components used for identifying the location of the subject vehicle M may be disposed to be independent from the navigation device 50. In addition, the navigation device 50, for example, may be realized by a function of a terminal device such as a smartphone, a tablet terminal, or the like held by a user or the like. In such a case, information is transmitted and received using wireless or wired communication between the terminal device and the vehicle control system 100.

The communication device 55, for example, performs radio communication using a cellular network, a Wi-Fi network, Bluetooth (registered trademark), dedicated short range communication (DSRC), or the like.

The vehicle sensor 60 includes a vehicle speed sensor detecting a vehicle speed, an acceleration sensor detecting an acceleration, a yaw rate sensor detecting an angular velocity around a vertical axis, an azimuth sensor detecting the azimuth of the subject vehicle M, and the like.

The display device 62 displays information as an image. The display device 62, for example, includes a liquid crystal display (LCD), an organic electroluminescence (EL) display device, or the like. In this embodiment, the display device 62 will be described as being a head-up display that displays an image inside the field of view of a vehicle occupant by reflecting the image onto a front window of the subject vehicle M. In addition, the display device 62 may be a display device included in the navigation device 50 or a display device of an instrument panel that displays the state (a speed and the like) of the subject vehicle M. The speaker 64 outputs information as speech.

The operation device 70, for example, includes an acceleration pedal, a steering wheel, a brake pedal, a shift lever, and the like. An operation detecting sensor 72 that detects the presence/absence of a driver's operation and the amount of the operation is mounted in the operation device 70. The operation detecting sensor 72, for example, includes an acceleration opening degree sensor, a steering torque sensor, a brake sensor, a shift position sensor, and the like. The operation detecting sensor 72 outputs an acceleration opening degree, a steering torque, a brake depression amount, a shift position, and the like to the running control unit 160 as detection results. Instead of this, a detection result acquired by the operation detecting sensor 72 may be directly output to the running driving force output device 200, the steering device 210, or the brake device 220.

The changeover switch 80 is a switch that is operated by a driver or the like. The changeover switch 80 accepts an operation of a driver or the like, generates a control mode designation signal used for designating a control mode according to the running control unit 160 as one of an automatic driving mode and a manual driving mode, and outputs the generated control mode designation signal to the switching control unit 150. The automatic driving mode, as described above, is a driving mode in which running is performed in a state in which a driver does not perform an operation (or the amount of operation is smaller than that of the manual driving mode, or the operation frequency is lower than that of the manual driving mode) and, more specifically, is a driving mode in which some or all of the running driving force output device 200, the steering device 210, and the brake device 220 are controlled on the basis of an action plan. In addition, the changeover switch 80 may accept various operations in addition to the operation of switching of the automatic driving mode.

Before description of the vehicle control system 100, the running driving force output device 200, the steering device 210, and the brake device 220 will be described.

The running driving force output device 200 outputs a running driving force (torque) used for running the vehicle to driving wheels. For example, the running driving force output device 200 includes an engine, a transmission, and an engine control unit (ECU) controlling the engine in a case in which the subject vehicle M is an automobile having an internal combustion engine as its power source, includes a running motor and a motor ECU controlling the running motor in a case in which the subject vehicle M is an electric vehicle having a motor as its power source, and includes an engine, a transmission, an engine ECU, a running motor, and a motor ECU in a case in which the subject vehicle M is a hybrid vehicle. In a case in which the running driving force output device 200 includes only an engine, the engine ECU adjusts a throttle opening degree, a shift level, and the like of the engine in accordance with information input from a running control unit 160 to be described later. On the other hand, in a case in which the running driving force output device 200 includes only a running motor, the motor ECU adjusts a duty ratio of a PWM signal given to the running motor in accordance with information input from the running control unit 160. In a case in which the running driving force output device 200 includes an engine and a running motor, an engine ECU and a motor ECU control a running driving force in cooperation with each other in accordance with information input from the running control unit 160.

The steering device 210, for example, includes a steering ECU and an electric motor.

The electric motor, for example, changes the direction of steered wheels by applying a force to a rack and pinion mechanism. The steering ECU changes the direction of the steering wheels by driving the electric motor in accordance with information input from the vehicle control system 100 or information of a steering angle or a steering torque that is input.

The brake device 220, for example, is an electric servo brake device including a brake caliper, a cylinder delivering hydraulic pressure to the brake caliper, an electric motor generating hydraulic pressure in the cylinder, and a brake control unit. The brake control unit of the electric servo brake device performs control of the electric motor in accordance with information input from the running control unit 160 such that a brake torque according to a braking operation is output to each vehicle wheel. The electric servo brake device may include a mechanism delivering hydraulic pressure generated by an operation of the brake pedal to the cylinder through a master cylinder as a backup. In addition, the brake device 220 is not limited to the electric servo brake device described above and may be an electronic control-type hydraulic brake device. The electronic control-type hydraulic brake device delivers hydraulic pressure of the master cylinder to the cylinder by controlling an actuator in accordance with information input from the running control unit 160. In addition, the brake device 220 may include a regenerative brake using the running motor which can be included in the running driving force output device 200.

### [Vehicle Control System]

Hereinafter, the vehicle control system 100 will be described. The vehicle control system 100, for example, is realized by one or more processors or hardware having functions equivalent thereto. The vehicle control system 100 may be configured by combining an electronic control unit (ECU), a micro-processing unit (MPU), or the like in which a processor such as a CPU, a storage device, and a communication interface are interconnected through an internal bus.

Referring to FIG. 2, the vehicle control system 100, for example, includes a target lane determining unit 110, an automatic driving control unit 120, a running control unit 160, and a storage unit 180. The automatic driving control unit 120, for example, includes, an automatic driving mode control unit 130, a subject vehicle position recognizing unit 140, an external system recognizing unit 142, an action plan generating unit 144, a locus generating unit 146, and a switching control unit 150. Some or all of the target lane determining unit 110, each unit of the automatic driving control unit 120, and the running control unit 160 are realized by a processor executing a program (software). In addition, some or all of these may be realized by hardware such as a large scale integration (LSI) or an application specific integrated circuit (ASIC) or may be realized by combining software and hardware.

In the storage unit 180, for example, information such as high-accuracy map information 182, target lane information 184, action plan information 186, and the like is stored. The storage unit 180 is realized by a read only memory (ROM), a random access memory (RAM), a hard disk drive (HDD), a flash memory, or the like. A program executed by the processor may be stored in the storage unit 180 in advance or may be downloaded from an external device through in-vehicle internet facilities or the like. In addition, a program may be installed in the storage unit 180 by mounting a portable-type storage medium storing the program in a drive device not illustrated in the drawing. Furthermore, the vehicle control system 100 may be distributed using a plurality of computer devices.

The target lane determining unit 110, for example, is realized by an MPU. The target lane determining unit 110 divides a route provided from the navigation device 50 into a plurality of blocks (for example, divides the route at every 100 [m] in the vehicle travelling direction) and determines a target lane for each block by referring to the high-accuracy map information 182. The target lane determining unit 110, for example, determines a lane, in which the subject vehicle runs, represented using a position from the left side. For example, in a case in which a branching point, a merging point, or the like is present in the route, the target lane determining unit 110 determines a target lane such that the subject vehicle M can run in a running route that is rational for advancing to a branching destination. The target lane determined by the target lane determining unit 110 is stored in the storage unit 180 as target lane information 184.

The high-accuracy map information 182 is a map information having a higher accuracy than that of the navigation map included in the navigation device 50. The high-accuracy map information 182, for example, includes information of the center of a lane or information of boundaries of a lane and the like. In addition, in the high-accuracy map information 182, road information, traffic regulations information, address information (an address and a zip code), facilities information, telephone number information, and the like may be included. In the road information, information representing a type of road such as an expressway, a toll road, a national road, or a prefectural road and information such as the number of lanes of a road, a width of each lane, a gradient of a road, the position of a road (three-dimensional coordinates including longitude, latitude, and a height), a curvature of the curve of a lane, locations of merging and branching points of lanes, signs installed on a road, and the like are included. In the traffic regulations information, information of closure of a lane due to roadwork, traffic accidents, congestion, or the like is included.

The automatic driving mode control unit 130 determines an automatic driving mode executed by the automatic driving control unit 120. The following modes are included in the automatic driving mode according to this embodiment. The following are merely examples, and the number and types of the automatic driving mode may be arbitrarily determined.

### [Mode A]

A mode A is a mode of which the degree of automatic driving is the highest. In a case in which the mode A is executed, the entire vehicle control such as complicated merging control is automatically performed, and accordingly, a vehicle occupant does not need to monitor the vicinity or the state of the subject vehicle M.

### [Mode B]

A mode B is a mode of which a degree of automatic driving is the second highest after the mode A. In a case in which the mode B is executed, generally, the entire vehicle control is automatically performed, but a driving operation of the subject vehicle M may be given over to a vehicle occupant in accordance with situations. For this reason, the vehicle occupant needs to monitor the vicinity and the state of the subject vehicle M.

### [Mode C]

A mode C is a mode of which a degree of automatic driving is the third highest after the mode B. In a case in which the mode C is executed, a vehicle occupant needs to perform a confirmation operation according to situations on the changeover switch 80. In the mode C, for example, in a case in which a timing for a lane change is notified to a vehicle occupant, and the vehicle occupant performs an operation of instructing a lane change with the changeover switch 80, automatic lane change is performed. For this reason, the vehicle occupant needs to monitor the vicinity and the state of the subject vehicle M.

The automatic driving mode control unit 130 determines an automatic driving mode on the basis of a vehicle occupant's operation on the changeover switch 80, an event determined by the action plan generating unit 144, a running mode determined by the locus generating unit 146, and the like. In the automatic driving mode, a limit according to the performance and the like of the detection device DD of the subject vehicle M may be set. For example, in a case in which the performance of the detection device DD is low, the mode A may not be executed. In any one of the modes, switching to a manual driving mode (overriding) can be made by performing an operation for the configuration of the driving operation system with the changeover switch 80.

The subject vehicle position recognizing unit 140 of the automatic driving control unit 120 recognizes a lane (running lane) in which the subject vehicle M is running and a relative position of the subject vehicle M with respect to the running lane on the basis of the high-accuracy map information 182 stored in the storage unit 180 and information input from the finder 20, the radar 30, the camera 40, the navigation device 50, or the vehicle sensor 60.

For example, the subject vehicle position recognizing unit 140 compares a pattern of road partition lines recognized in the high-accuracy map information 182 (for example, an array of solid lines and broken lines) with a pattern of road partition lines in the vicinity of the subject vehicle M that has been recognized in an image captured by the camera 40, thereby recognizing a running lane.

In the recognition, the position of the subject vehicle M acquired from the navigation device 50 or a result of the process executed by an INS may be additionally taken into account.

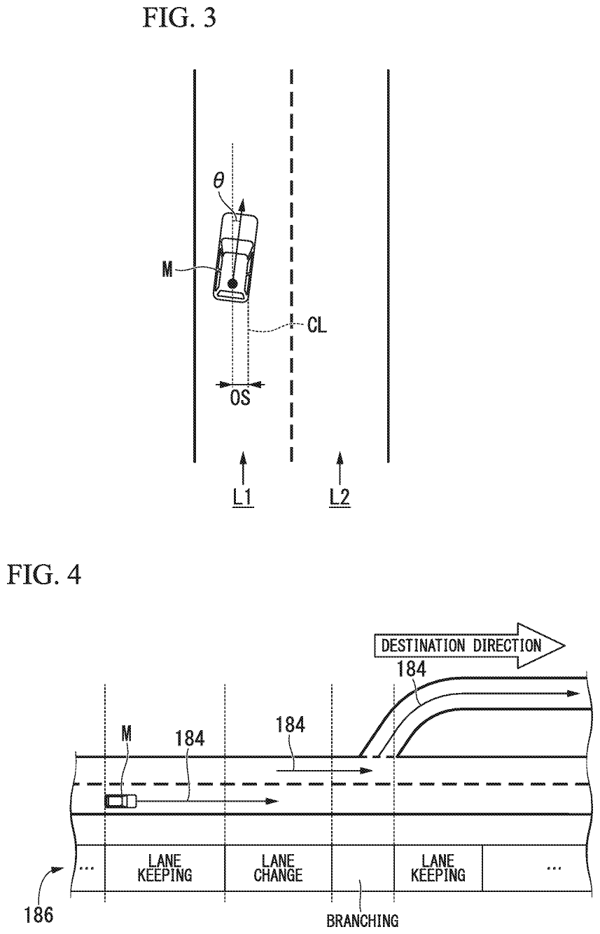

FIG. 3 is a diagram illustrating a view in which a relative position of a subject vehicle M with respect to the running lane L1 is recognized by the subject vehicle position recognizing unit 140. For example, the subject vehicle position recognizing unit 140 recognizes an offset OS of a reference point (for example, the center of gravity) of the subject vehicle M from the center CL of the running lane and an angle θ of a travelling direction of the subject vehicle M formed with respect to a line along the center CL of the running lane as a relative position of the subject vehicle M with respect to the running lane L1. In addition, instead of this, the subject vehicle position recognizing unit 140 may recognize a position of a reference point on the subject vehicle M with respect to one side end part of the running lane L1 and the like as a relative position of the subject vehicle M with respect to the running lane. The relative position of the subject vehicle M recognized by a subject vehicle position recognizing unit 140 is provided to the target lane determining unit 110.

The external system recognizing unit 142 recognizes states of each surrounding vehicle such as a position, a speed, an acceleration, and the like thereof on the basis of information input from the finder 20, the radar 30, the camera 40, and the like. For example, a surrounding vehicle is a vehicle running in the vicinity of the subject vehicle M and is a vehicle running in the same direction as that of the subject vehicle M. The position of a surrounding vehicle may be represented as a representative point on another vehicle such as the center of gravity, a corner, or the like and may be represented by an area represented by the contour of another vehicle. The “state” of a surrounding vehicle may include an acceleration of a surrounding vehicle and whether or not a lane is being changed (or whether or not a lane is to be changed) acquired on the basis of information of various devices described above. In addition, the external system recognizing unit 142 may recognize positions of a guard rail, a telegraph pole, a parked vehicle, a pedestrian, and other objects in addition to the surrounding vehicles.

The action plan generating unit 144 sets a start point of automatic driving and/or a destination of automatic driving. The start point of automatic driving may be the current position of the subject vehicle M or a point at which an operation instructing automatic driving is performed. The action plan generating unit 144 generates an action plan for a section between the start point and a destination of the automatic driving. The section is not limited thereto, and the action plan generating unit 144 may generate an action plan for an arbitrary section.

The action plan, for example, is configured of a plurality of events that are sequentially executed. The events, for example, include a deceleration event of decelerating the subject vehicle M, an acceleration event of accelerating the subject vehicle M, a lane keeping event of causing the subject vehicle M to run without deviating from a running lane, a lane changing event of changing a running lane, an overtaking event of causing the subject vehicle M to overtake a preceding vehicle, a branching event of changing lane to a desired lane at a branching point or causing the subject vehicle M to run without deviating from a current running lane, a merging event of accelerating/decelerating the subject vehicle M and changing a running lane in a merging lane for merging into a main lane, and a handover event of transitioning from a manual driving mode to an automatic driving mode at a start point of automatic driving or transitioning from an automatic driving mode to a manual driving mode at a planned end point of automatic driving, and the like. The action plan generating unit 144 sets a lane changing event, a branching event, or a merging event at a place at which a target lane determined by the target lane determining unit 110 is changed. Information representing the action plan generated by the action plan generating unit 144 is stored in the storage unit 180 as action plan information 186.

FIG. 4 is a diagram illustrating one example of an action plan generated for a certain section. As illustrated in the drawing, the action plan generating unit 144 generates an action plan that is necessary for the subject vehicle M to run on a target lane indicated by the target lane information 184. In addition, the action plan generating unit 144 may dynamically change the action plan in accordance with a change in the status of the subject vehicle M regardless of the target lane information 184. For example, in a case in which a speed of a surrounding vehicle recognized during the running of the vehicle by the external system recognizing unit 142 exceeds a threshold, or a moving direction of a surrounding vehicle running on a lane adjacent to the own lane is directed toward the direction of the own lane, the action plan generating unit 144 may change the event set in a driving section on which the subject vehicle M plans to run. For example, in a case in which an event is set such that a lane changing event is executed after a lane keeping event, when it is determined that a vehicle is running at a speed that is a threshold or more from the behind in a lane that is a lane change destination during the lane keeping event in accordance with a result of the recognition of the external system recognizing unit 142, the action plan generating unit 144 may change the next event after a lane keeping event from a lane changing event to a deceleration event, a lane keeping event, or the like. As a result, also in a case in which a change in the state of the external system occurs, the vehicle control system 100 can cause the subject vehicle M to safely run automatically.

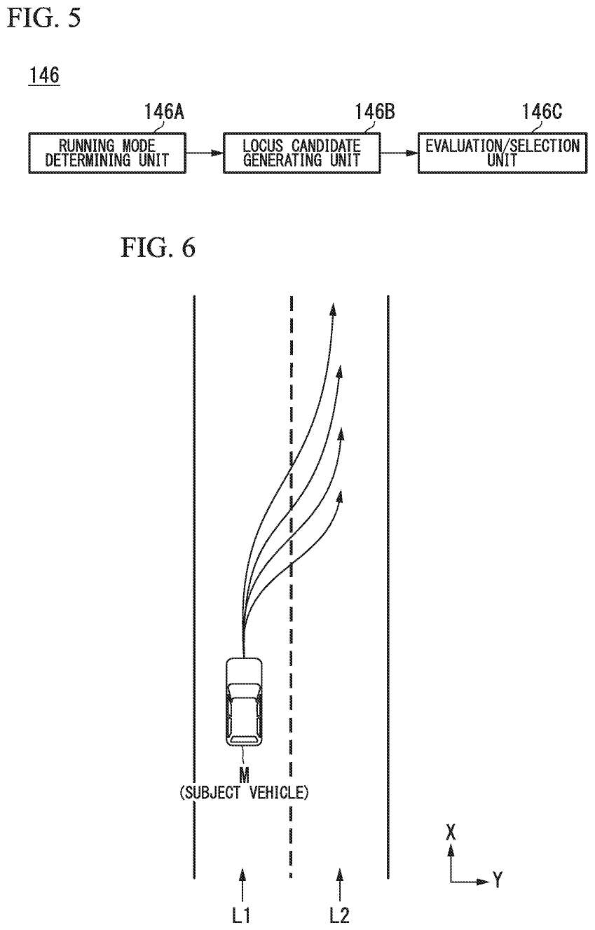

FIG. 5 is a diagram illustrating one example of the configuration of the locus generating unit 146. The locus generating unit 146, for example, includes a running mode determining unit 146A, a locus candidate generating unit 146B, and an evaluation/selection unit 146C.

For example, when a lane keeping event is executed, the running mode determining unit 146A may determine one running mode among constant-speed running, following running, low-speed following running, decelerating running, curve running, obstacle avoidance running, and the like. In this case, in a case in which another vehicle is not present in front of the subject vehicle M, the running mode determining unit 146A may determine constant-speed running as the running mode. In addition, in a case in which following running for a preceding vehicle is to be executed, the running mode determining unit 146A may determine following running as the running mode. In addition, in the case of congestion or the like, the running mode determining unit 146A may determine low-speed following running as the running mode. Furthermore, in a case in which deceleration of a preceding vehicle is recognized by the external system recognizing unit 142 or in a case in which an event of stopping, parking, or the like is to be executed, the running mode determining unit 146A may determine decelerating running as the running mode. In addition, in a case in which the subject vehicle M is recognized to have reached a curved road by the external system recognizing unit 142, the running mode determining unit 146A may determine curve running as the running mode. Furthermore, in a case in which an obstacle is recognized in front of the subject vehicle M by the external system recognizing unit 142, the running mode determining unit 146A may determine obstacle avoidance running as the running mode. In addition, in a case in which a lane changing event, an overtaking event, a branching event, a merging event, a handover event, or the like is executed, the running mode determining unit 146A may determine a running mode corresponding to each event.

The locus candidate generating unit 146B generates candidates for a locus on the basis of the running mode determined by the running mode determining unit 146A. FIG. 6 is a diagram illustrating one example of candidates for a locus that are generated by the locus candidate generating unit 146B. FIG. 6 illustrates candidates for loci generated in a case in which a subject vehicle M changes lanes from a lane L1 to a lane L2.

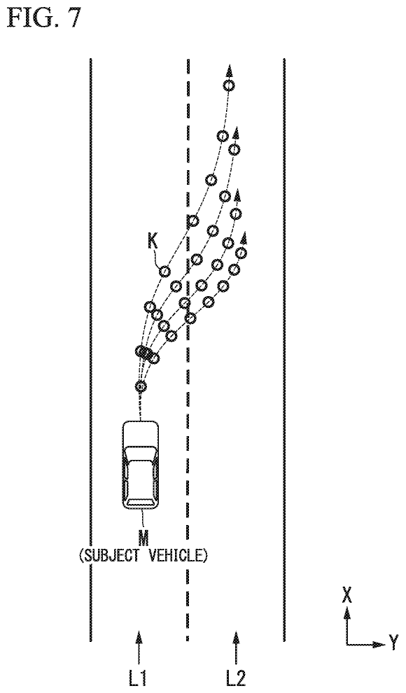

The locus candidate generating unit 146B, for example, determines loci as illustrated in FIG. 6 as aggregations of target locus points (locus points K) that a predetermined position (for example, the center of gravity or the center of a rear wheel shaft) on the subject vehicle M will reach at predetermined times in the future. FIG. 7 is a diagram in which candidates for a locus generated by the locus candidate generating unit 146B are represented using locus points K. As a gap between the locus points K becomes wider, the speed of the subject vehicle M increases. On the other hand, as a gap between the locus points K becomes narrower, the speed of the subject vehicle M decreases. Thus, in a case in which acceleration is desired, the locus candidate generating unit 146B gradually increases the gap between the locus points K. On the other hand, in a case in which deceleration is desired, the locus candidate generating unit 146B gradually decreases the gap between the locus points.

In this way, since the locus points K include a speed component, the locus candidate generating unit 146B needs to give a target speed to each of the locus points K. The target speed is determined in accordance with the running mode determined by the running mode determining unit 146A.

Here, a technique for determining a target speed in a case in which a lane change (including branching) is performed will be described.

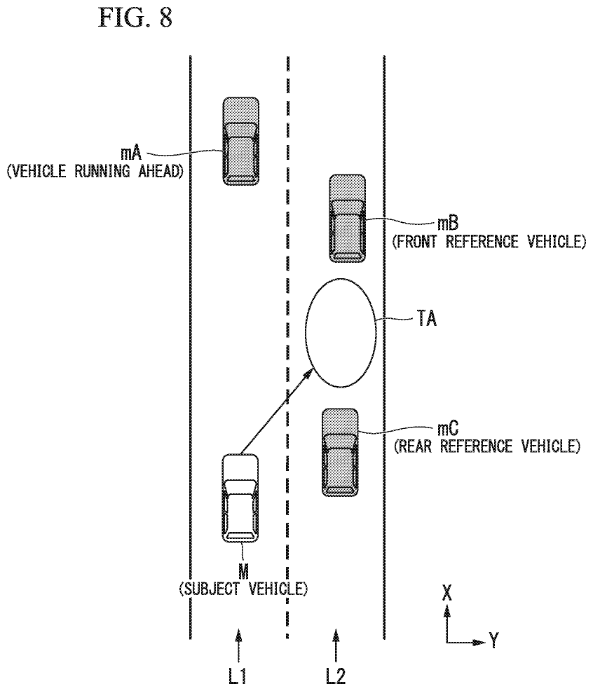

The locus candidate generating unit 146B, first, sets a lane change target position (or a merging target position). The lane change target position is set as a relative position with respect to a surrounding vehicle and is for determining “surrounding vehicles between which a lane change is performed.” The locus candidate generating unit 146B determines a target speed of a case in which a lane change is performed focusing on three surrounding vehicles using the lane change target position as a reference. FIG. 8 is a diagram illustrating a lane change target position TA.

In the drawing, an own lane L1 is illustrated, and an adjacent lane L2 is illustrated. Here, in the same lane as that of the subject vehicle M, a surrounding vehicle running immediately before the subject vehicle M will be defined as a vehicle mA running ahead, a surrounding vehicle running immediately before the lane change target position TA will be defined as a front reference vehicle mB, and a surrounding vehicle running immediately after the lane change target position TA will be defined as a rear reference vehicle mC. When the subject vehicle M needs to perform acceleration/deceleration for movement to the lateral side of the lane change target position TA, at this time, overtaking the vehicle mA running ahead needs to be avoided. For this reason, the locus candidate generating unit 146B predicts future states of the three surrounding vehicles and sets a target speed such that there is no interference with each of the surrounding vehicles.

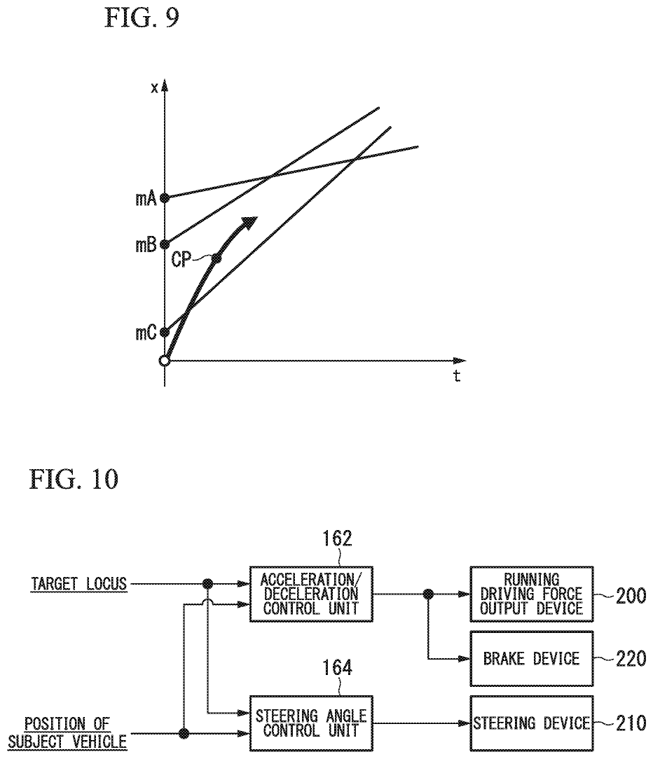

FIG. 9 is a diagram illustrating a speed generation model of a case in which the speeds of three surrounding vehicles are assumed to be constant. In the drawing, straight lines extending from mA, mB, and mC respectively represent displacements in the travelling direction in a case in which each of the surrounding vehicles is assumed to run at a constant speed. At a point CP at which the lane change is completed, the subject vehicle M needs to be present between the front reference vehicle mB and the rear reference vehicle mC and needs to be present behind the vehicle mA running ahead before that. Under such restrictions, the locus candidate generating unit 146B derives a plurality of time series patterns of the target speed until the lane change is completed. Then, by applying the time series patterns of the target speed to a model of a spline curve or the like, a plurality of candidates for loci as illustrated in FIG. 7 are derived. In addition, the movement patterns of the three surrounding vehicles are not limited to constant speeds as illustrated in FIG. 9 and may be predicted on the premise of constant accelerations or constant jerks (derivatives of accelerations).

The evaluation/selection unit 146C performs evaluations for the generated candidates for the locus generated by the locus candidate generating unit 146B, for example, from two viewpoints of planning and safety and selects a target locus to be output to the running control unit 160. From the viewpoint of planning, for example, a locus is evaluated highly in a case in which the ability to follow a plan that has already been generated (for example, an action plan) is high, and the total length of the locus is short. For example, in a case in which it is desirable to perform a lane change to the right side, a locus in which a lane change to the left side is temporarily performed, and then, the subject vehicle returns has a low evaluation. From the viewpoint of safety, for example, in a case in which, at each locus point, a distance between the subject vehicle M and an object (a surrounding vehicle or the like) is long, and the amounts of changes in the acceleration/deceleration and the steering angle are small, the locus is evaluated highly.

The switching control unit 150 performs switching between the automatic driving mode and the manual driving mode on the basis of a signal input from the changeover switch 80. In addition, the switching control unit 150 switches the driving mode from the automatic driving mode to the manual driving mode on the basis of an operation instructing acceleration, deceleration, or steering on the operation device 70. For example, in a case in which a state in which the amount of operation represented by a signal input from the operation device 70 exceeds a threshold continues for a reference time or more, the switching control unit 150 may switch the driving mode from the automatic driving mode to the manual driving mode (overriding). In addition, in a case in which an operation on the operation device 70 has not been detected for a predetermined time after the switching to the manual driving mode according to overriding, the switching control unit 150 may return the driving mode to the automatic driving mode.

The running control unit 160, for example, as illustrated in FIG. 2, includes an acceleration/deceleration control unit 162 and a steering angle control unit 164. The running control unit 160 performs control of the running driving force output device 200, the steering device 210, and the brake device 220 such that the subject vehicle M passes along a locus generated by the locus candidate generating unit 146B at planned times (times associated with the locus points). In this embodiment, although the steering angle control unit 164 is described as a part of the running control unit 160, the steering angle control unit 164 may be a part of the locus generating unit 146.

FIG. 10 is a diagram illustrating relations between the acceleration/deceleration control unit 162 and the steering angle control unit 164 and control targets thereof. A target locus is supplied from the locus generating unit 146 of the automatic driving control unit 120 to the acceleration/deceleration control unit 162 and the steering angle control unit 164, and the position of the subject vehicle identified by the navigation device 50 and the subject vehicle position recognizing unit 140 is supplied thereto. The acceleration/deceleration control unit 162 controls the running driving force output device 200 and the brake device 220 on the basis of the target locus acquired from the automatic driving control unit 120 and the position of the subject vehicle M. The steering angle control unit 164 controls the steering device 210 on the basis of the target locus acquired from the automatic driving control unit 120 and the position of the subject vehicle M.

### [Function of Steering Angle Control Unit]

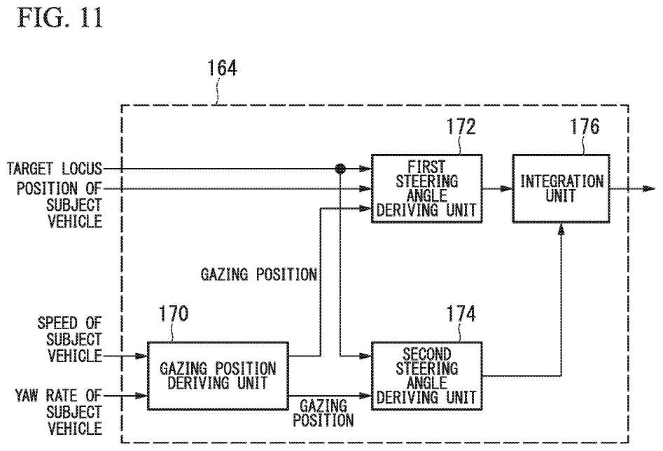

FIG. 11 is a diagram illustrating one example of the function of the steering angle control unit 164. The steering angle control unit 164, for example, includes a gazing position deriving unit 170, a first steering angle deriving unit 172, a second steering angle deriving unit 174, and an integration unit 176.

The gazing position deriving unit 170 derives a gazing position (reference position) of the subject vehicle M. The gazing position deriving unit 170 sets a position on a target locus of the subject vehicle M acquired in a case in which the subject vehicle M is assumed to run on the target locus from a position on the target locus that is closest to the position of the subject vehicle M for a predetermined time as a gazing position.

The first steering angle deriving unit 172 controls the steering of the subject vehicle M on the basis of a virtual circular arc that has a tangent along a travelling direction of the subject vehicle M and passes through the gazing position and the position of the subject vehicle M. Here, the travelling direction of the subject vehicle M may be a direction of a center axis of the vehicle, a direction in which a velocity vector of the subject vehicle M at the moment is directed, or one of directions acquired by performing correction based on a yaw rate for these.

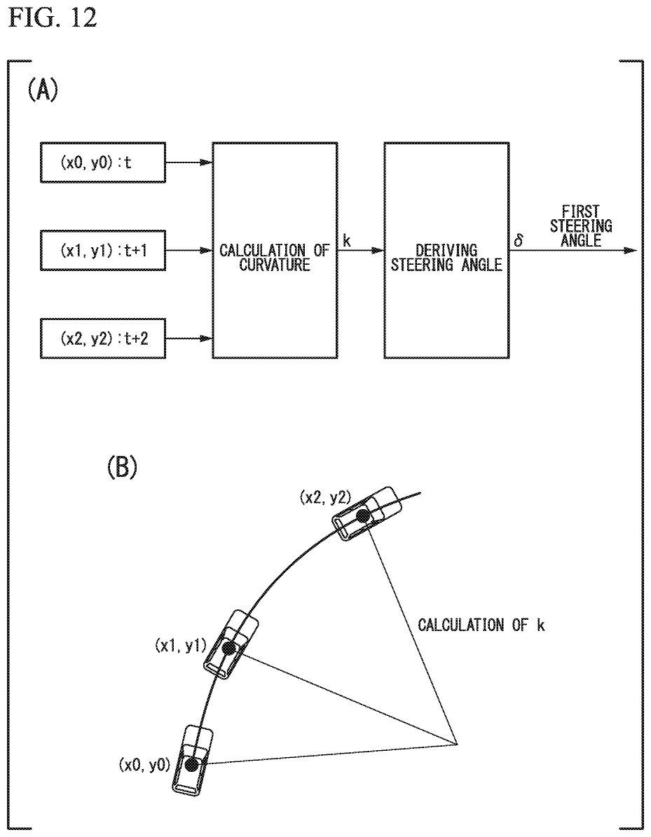

FIG. 12 is a diagram illustrating a steering angle deriving process performed by the first steering angle deriving unit 172. FIG. 12(A) illustrates the flow of the first steering angle deriving process, and FIG. 12(B) illustrates transitions of the position of the subject vehicle. The first steering angle deriving unit 172 assumes that the subject vehicle M moves on a predetermined regular circle. Here, for example, the regular circle is a circular locus in a case in which running is performed in a state in which the steering wheel is steered at a certain steering angle.

For example, the first steering angle deriving unit 172 derives the position of the subject vehicle M at a time t (current position; x0, y0), the position of the subject vehicle M at a time t+1 (x1, y1), and the position of the subject vehicle M at a time t+2 (x2, y2) in the target locus. The first steering angle deriving unit 172 derives a curvature of the regular circle by assuming that the subject vehicle M moves on a regular circle passing through the positions of these three points at a certain time. The first steering angle deriving unit 172 derives a steering angle of the subject vehicle M on the basis of the following Equation (1) by assuming that the subject vehicle M moves in the regular circle in a steady state. In the following Equation (1), δ represents a steering angle (steering wheel angle), k represents a curvature of the regular circle, A represents a stability factor, V represents a vehicle speed, L represents an inter-axial distance, and n represents a gear ratio. The steering angle, for example, is represented as an absolute value, which is the same in the following description.

δ=k×(1+A×V²)×L×n (1)

In addition, the first steering angle deriving unit 172 may derive the position of the subject vehicle M at a time t (current position; x0, y0), the position of the subject vehicle M at a time t−1 (−x1, −y1), and the position of the subject vehicle M at a time t+1 (x1, y1) in the target locus and derive a curvature using a normal circle passing through the positions of these three points.

In addition, in a case in which the curvature of the circular arc exceeds a predetermined value (a second predetermined value), the first steering angle deriving unit 172 may limit the control of the steering of the subject vehicle M by correcting the curvature of the circular arc to a predetermined value or less. The circular arc is a part of the circumference of the regular circle.

The second steering angle deriving unit 174 derives a second steering angle for increasing the control of the steering of the subject vehicle M as a deviation between the gazing position and the position of the subject vehicle M in a direction orthogonal to the travelling direction of the subject vehicle M increases.

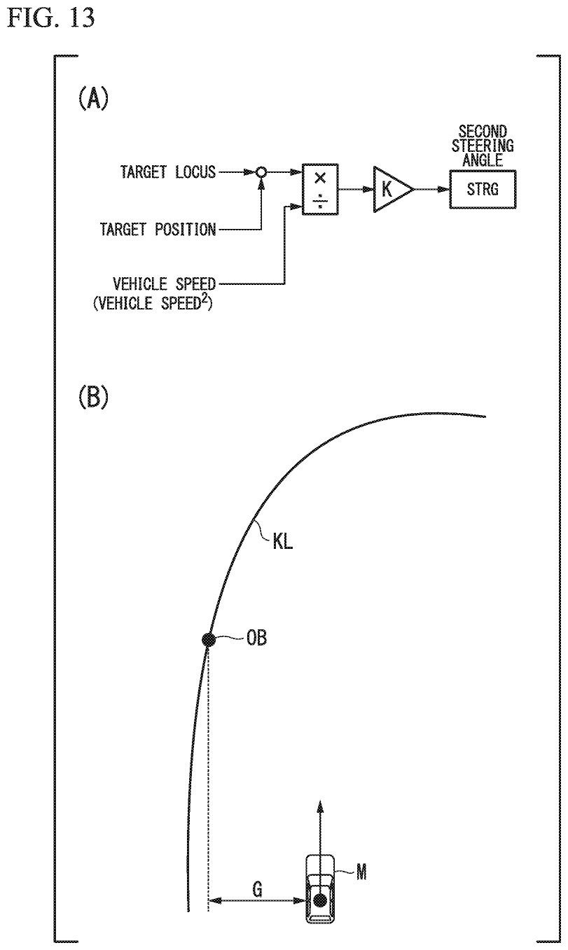

FIG. 13 is a conceptual diagram of the deriving of the second steering angle using the second steering angle deriving unit 174.

FIG. 13(A) illustrates the flow of the process of deriving the second steering angle, and FIG. 13(B) illustrates a view in which the second steering angle is derived. The second steering angle deriving unit 174 derives a deviation G between a gazing position OB on a target locus KL in a direction orthogonal to the travelling direction of the subject vehicle M and the position of the subject vehicle M in the horizontal direction. In addition, the second steering angle deriving unit 174 derives an index value on the basis of a function having the deviation G and the vehicle speed as parameters and derives a new index value by taking a coefficient K into account for the derived index value. In addition, the second steering angle deriving unit 174 derives a second steering angle on the basis of the derived new index value and the vehicle speed. In addition, in a case in which the deviation G is equal to or greater than a predetermined value (first predetermined value), or in a case in which the second steering angle is equal to or greater than a predetermined angle, the second steering angle deriving unit 174 may limit the control of the steering of the subject vehicle M. In this way, the second steering angle deriving unit 174 can suppress the subject vehicle M from making a sudden turn.

The integration unit 176 derives a steering angle to be output to the steering device 210 by integrating the first steering angle and the second steering angle. The integration unit 176 may change weighting factors of the first steering angle and the second steering angle in accordance with the vehicle speed. More specifically, the integration unit 176 sets a weighting factor of the first steering angle to be larger than the weighting factor of the second steering angle in the case of a low vehicle speed (for example, the vehicle speed is equal to or less than a first predetermined speed). The reason for this is that the first steering angle derived on the basis of the circular arc has low error at a low speed. On the other hand, by setting the weighting factor of the second steering angle to be larger than the weighting factor of the first steering angle at a high speed (equal to or higher than a second predetermined speed), a deviation of the first steering angle can be compensated.

### [Process of Steering Angle Control Unit]

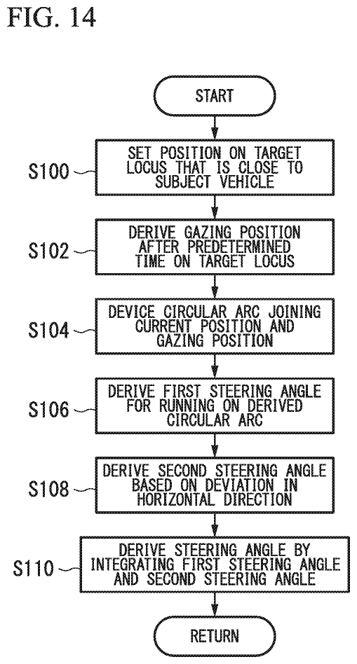

FIG. 14 is a flowchart illustrating the flow of a process executed by the steering angle control unit 164. This process is executed for every processing period of the automatic driving control unit 120.

First, the gazing position deriving unit 170 of the steering angle control unit 164 sets a position on the target locus that is close to the subject vehicle M (Step S100). Next, the steering angle control unit 164 derives a gazing position of the subject vehicle M after a predetermined time on the basis of the set position and the vehicle speed of the subject vehicle M (Step S102).

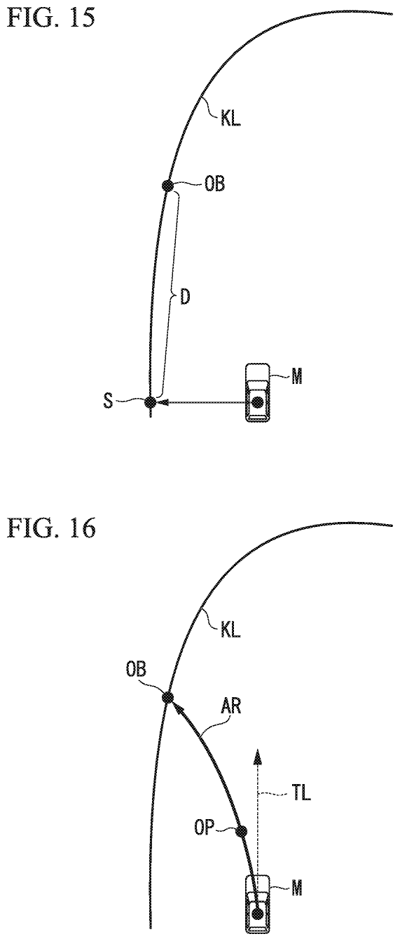

FIG. 15 is a diagram illustrating one example of a view in which a gazing position is derived. FIG. 15 illustrates a view in which a position of the subject vehicle M deviates from the target locus. Here, deviating represents that a “predetermined position” such as the center of gravity of the subject vehicle M or the like is away from a position that is the closest to the “predetermined position” in the target locus by a predetermined distance or more. As illustrated in FIG. 15, the gazing position deriving unit 170 sets a starting point S that is a position on the target locus KL that is the closest to the subject vehicle M. The gazing position deriving unit 170 sets a position after the subject vehicle M runs from the starting point S for a predetermined time Tref (or a position after running over predetermined distance; hereinafter the same) as a gazing position OB. The gazing position deriving unit 170 multiplies the vehicle speed by the predetermined time Tref, thereby deriving a distance D that the subject vehicle M runs for the predetermined time Tref. The gazing position deriving unit 170 sets a position of the distance D on the target locus KL from the starting point S as a gazing position OB.

The predetermined time Tref used for acquiring the gazing position OB described above is a long time relative to one sampling time Ts for which the running control unit 160 executes the process. For example, in a case in which the processing period of the running control unit 160 is 0.1 seconds, the predetermined time Tref is 0.5 seconds. In such a case, the gazing position OB is a position assumed to be a position at which the subject vehicle M is located after 0.5 seconds.

Next, the first steering angle deriving unit 172 derives a circular arc joining the current position of the subject vehicle M and the gazing position OB (Step S104). Next, the first steering angle deriving unit 172 derives a first steering angle for running on the derived circular arc (Step S106).

FIG. 16 is a diagram illustrating a circular arc AR derived by the first steering angle deriving unit 172. As illustrated in FIG. 16, the first steering angle deriving unit 172 derives a circular arc AR that joins the current position of the subject vehicle M and the gazing position OB. The circular arc AR, for example, has a tangent TL along the travelling direction of the subject vehicle M and passes through the gazing position OB and the position of the subject vehicle M. Then, the first steering angle deriving unit 172 derives a steering angle for running on the derived circular arc AR. In the drawing, OP is a moving position on the circular arc AR acquired when it is assumed that the subject vehicle M has run in accordance with the process of the running control unit 160 for one sampling time Ts.

Next, the second steering angle deriving unit 174 derives a second steering angle on the basis of a deviation between the subject vehicle M and the gazing position OB in the horizontal direction (Step S108).

Next, the integration unit 176 derives a steering angle used for control by integrating the first steering angle and the second steering angle (Step S110). The integration unit 176 may derive a steering angle by adding the first steering angle and the second steering angle or may device a steering angle by acquiring a weighted sum of the first steering angle and the second steering angle using weighting factors. In addition, in a case in which the derived steering angle is equal to or greater than a predetermined angle, the integration unit 176 may limit the steering angle to a predetermined angle or an angle that is equal to or less than a predetermined angle. In this way, the process of this flowchart ends.

In a case in which some or all of the first steering angle, the second steering angle, and the steering angle derived by the integration unit 176 is equal to or greater than a predetermined angle, the steering angle control unit 164 may prompt a vehicle occupant to perform handover before the steering angle is controlled as being equal to or greater than a predetermined angle. In such a case, for example, the steering angle control unit 164 outputs a notification used for prompting handover to the speaker 64 or the display device 62. In this way, it is suppressed that the steering angle is controlled as being equal to or greater than the predetermined angle in automatic driving. In addition, it is suppressed that a vehicle occupant performs handover in a state in which the steering of the steering angle at the predetermined angle or more is not recognized.

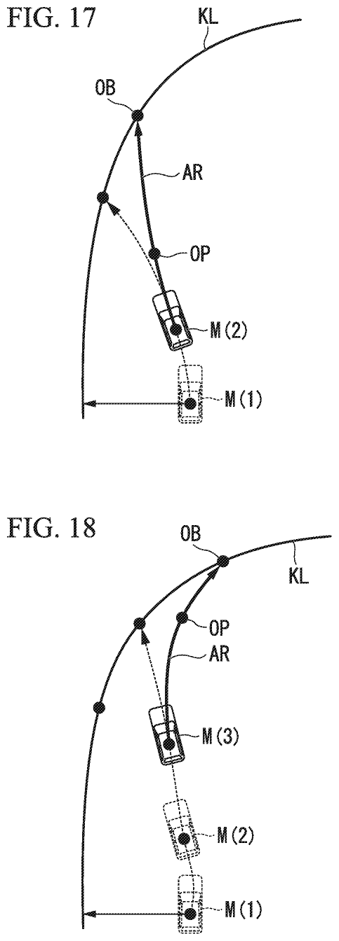

Views in which the subject vehicle M is controlled will be described with reference to FIGS. 17 to 20. FIGS. 17 to 20 represent one example illustrating views in which the subject vehicle M is controlled in processing periods (2) to (5). The steering angle control unit 164 derives a steering angle for every processing period. The subject vehicle M is controlled on the basis of a steering angle derived for every processing period. FIG. 16 described above illustrates the processing period (1).

In the processing period (1), a gazing position OB of the subject vehicle M for the next processing period (2) is assumed to be derived. As illustrated in FIG. 17, in the processing period (2), the subject vehicle M moves to a moving position OP on the circular arc AR derived in the processing period (1). Then, a circular arc AR of the subject vehicle M in the processing period (3) is derived.

As illustrated in FIG. 18, in the processing period (3), the subject vehicle M moves to a moving position OP on the circular arc AR derived in the processing period (2), and a circular arc AR of the subject vehicle M in the processing period (4) is derived.

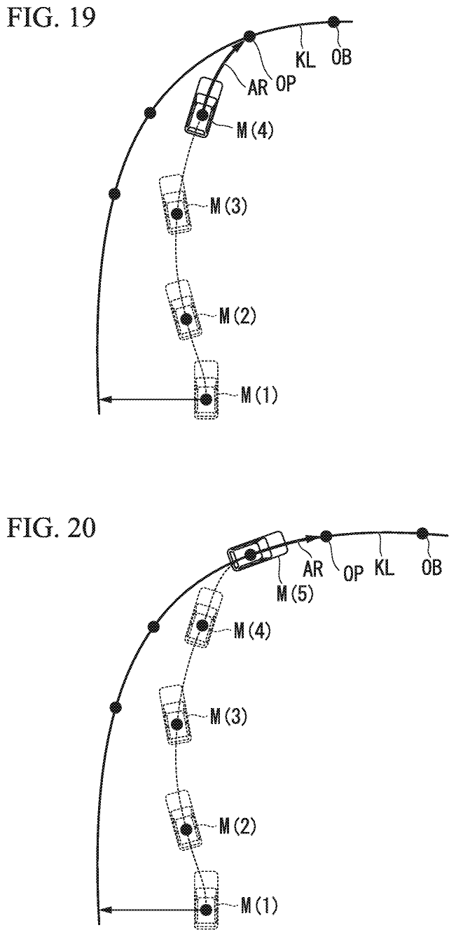

As illustrated in FIG. 19, in the processing period (4), the subject vehicle M moves to a moving position OP on the circular arc AR derived in the processing period (3), and, as illustrated in FIG. 20, in the processing period (5), the subject vehicle M moves to a moving position OP on the circular arc AR derived in the processing period (4).

In this way, a gazing position OB is derived for every processing period, and a circular arc AR connecting the gazing position OB and the subject vehicle M is derived. The steering angle control unit 164 derives a steering angle on the basis of the derived circular arc AR. As a result, the subject vehicle M can come close to the target locus in a smooth locus.

In addition, the subject vehicle M can enter the target locus to follow the target locus. As a result, smoother steering control can be realized.

In the description presented above, as an example, while the view in which the position of the subject vehicle M deviates from the target locus by a predetermined distance or more has been described, here, the process of a view in which the position of the subject vehicle M does not deviate from the target locus by a predetermined distance or more and a view in which the position of the subject vehicle M and the target locus coincide with each other will be described.

The gazing position deriving unit 170 derives a gazing position of the subject vehicle M in accordance with the curvature of the target locus.

For example, the gazing position deriving unit 170 derives a gazing position as being closer to the vicinity of the subject vehicle M as the curvature of the target locus becomes larger and derives a gazing position to be further away from the subject vehicle M as the curvature of the target locus becomes closer to zero (straight line). The first steering angle deriving unit 172, for example, derives a circular arc joining the current position of the subject vehicle M and the gazing position and derives a first steering angle for running on the derived circular arc.

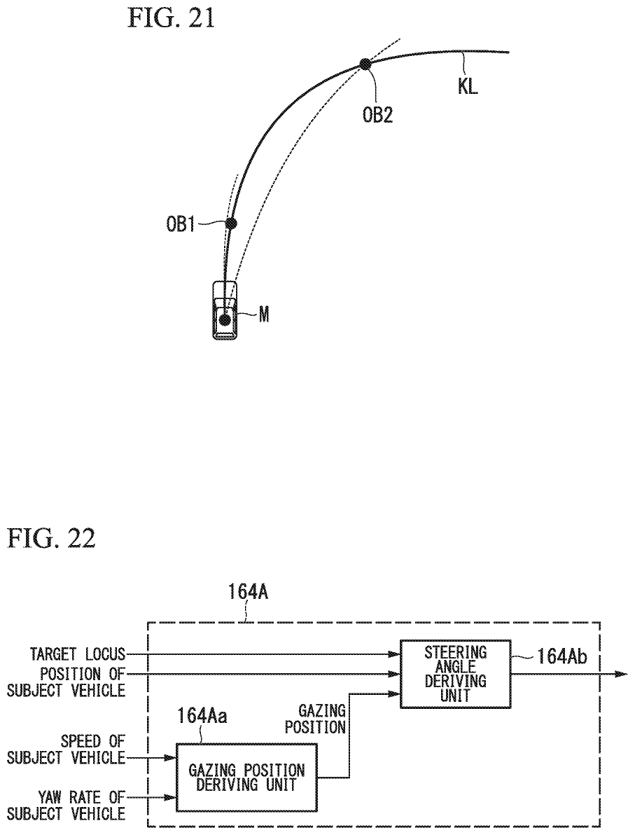

FIG. 21 is a diagram illustrating one example of a gazing position derived in a case in which a target locus has a predetermined curvature. In a case in which the position of the subject vehicle M is present on the target locus, the gazing position deriving unit 170, in a case in which the target locus has a predetermined curvature, derives a position OB1 close to the subject vehicle M as a gazing position. In such a case, the radius of a circular arc passing through the subject vehicle M and the position OB1 becomes smaller, and the subject vehicle M runs in a state in which a deviation from the target locus is small. For example, when the gazing position deriving unit 170 derives a gazing position as a position OB2 far from the subject vehicle M, a circular arc passing through the gazing position and the subject vehicle M deviates from the target locus, and accordingly, the subject vehicle M runs in a state in which a deviation from the target locus is large.

In this way, since a gazing position of the subject vehicle M is derived in accordance with a curvature of the target locus, in a case in which the curvature of the target locus is large, the radius of the circular arc becomes small, and the subject vehicle M is controlled such that the ability to follow the target locus is good. As a result, a deviation between the target locus having a large curvature and the position of the subject vehicle M is suppressed from occurring. In addition, in a case in which the curvature of the target locus is close to zero, the radius of the circular arc become large and becomes close to a straight line, and accordingly, the running stability of the subject vehicle M is improved.

In addition, the gazing position deriving unit 170 derives the gazing position of the subject vehicle M in accordance with a target speed given for each locus point K of the target locus. For example, as the target speed becomes higher, the gazing position deriving unit 170 derives a gazing position to be farther away for the improvement of the running stability. On the other hand, as the target speed becomes lower, the gazing position deriving unit 170 derives a gazing position to be nearer for the control of the subject vehicle to have a good ability to follow the target locus.

For example, the target locus is a locus in which the subject vehicle M can run with a gravitational acceleration in the horizontal direction (lateral G) being equal to or less than a predetermined value. In a curved road, for example, the target speed is set to be equal to or less than a predetermined speed such that the lateral G does not exceed a predetermined value. Accordingly, a gazing position on the curved road becomes closer to the subject vehicle M than a gazing position in a straight road.

As described above, in a case in which the curvature of the target locus is small or in a case in which the target vehicle speed is high, the gazing position is set to be father away from the subject vehicle M, and accordingly, the behavior of the subject vehicle M becomes stable. On the other hand, in a case in which the curvature of the target locus is large or in a case in which the target vehicle speed is low, the gazing position is set to be closer to the subject vehicle M, and accordingly, the subject vehicle M is controlled to have a good ability to follow the target locus, and accordingly, a deviation between the target locus and the subject vehicle M is suppressed.

In addition, the second steering angle deriving unit 174 derives a second steering angle on the basis of a deviation between the subject vehicle M and the gazing position OB in the horizontal direction. The integration unit 176 derives a steering angle in which a relation between the position of the subject vehicle M and the target locus is taken into account by integrating the first steering angle and the second steering angle.

According of the first embodiment described above, the vehicle control system 100 controls the steering of the subject vehicle M on the basis of the first steering angle derived on the basis of the circular arc AR that has the tangent TL along the travelling direction of the subject vehicle M and passes through the gazing position OB and the position of the subject vehicle M and the second steering angle for increasing control of the steering of the subject vehicle M as a deviation between the gazing position OB and the position of the subject vehicle M in a direction orthogonal to the travelling direction of the subject vehicle M becomes larger, whereby smoother steering control can be realized.

### Second Embodiment

Hereinafter, a second embodiment will be described. FIG. 22 is a diagram illustrating one example of the function of a steering angle control unit 164A according to the second embodiment. In the steering angle control unit 164A according to the second embodiment, the second steering angle deriving unit 174 and the integration unit 176 may be omitted. Compared to the first embodiment, the steering angle control unit 164A includes a gazing position deriving unit 164Aa and a steering angle deriving unit 164Ab. The gazing position deriving unit 164Aa and the steering angle deriving unit 164Ab respectively have functions equivalent to those of the gazing position deriving unit 170 and the first steering angle deriving unit 172 according to the first embodiment. Hereinafter, differences from the first embodiment will be focused in description.

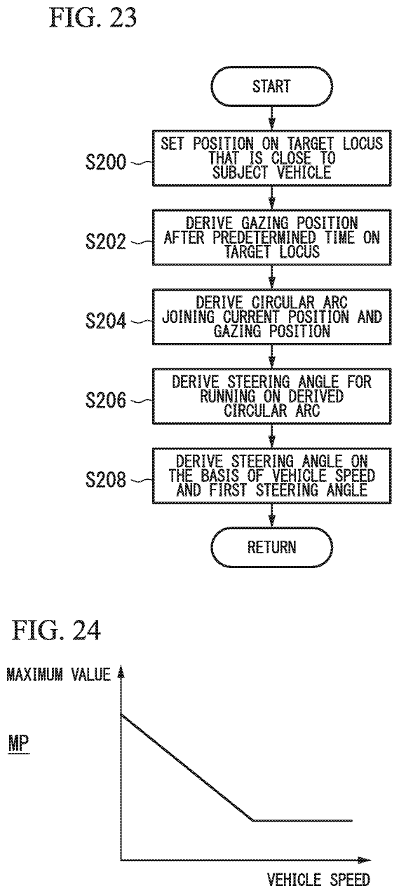

FIG. 23 is a flowchart illustrating the flow of a process executed by the steering angle control unit 164A.

First, the gazing position deriving unit 164Aa of the steering angle control unit 164A sets a position on the target locus that is close to the subject vehicle M (Step S200). Next, the steering angle control unit 164A derives a gazing position of the subject vehicle M after a predetermined time on the basis of the set position and the vehicle speed of the subject vehicle M (Step S202).

Next, the steering angle deriving unit 164Ab derives a circular arc joining the current position of the subject vehicle M and the gazing position (Step S204). Next, the steering angle deriving unit 164Ab derives a steering angle for running on the derived circular arc (Step S206).

Next, the steering angle deriving unit 164Ab derives a steering angle on the basis of the vehicle speed and the first steering angle (Step S208). In this way, the process of this flowchart ends. For example, the steering angle deriving unit 164Ab derives a steering angle by referring to a steering angle map MP associated with the vehicle speed and a maximum steering angle. The steering angle deriving unit 164Ab derives a steering angle such that the steering angle is limited as being equal to or less than a predetermined angle by referring to the steering angle map MP. FIG. 24 is a diagram illustrating one example of the steering angle map MP. The vertical axis represents a maximum value of the steering angle, and the horizontal axis represents a vehicle speed. In the steering angle map MP, in a case in which the vehicle speed is equal to or less than a predetermined vehicle speed, a maximum value of the steering angle becomes smaller as the vehicle speed increases, and, in a case in which the vehicle speed exceeds the predetermined vehicle speed, a maximum value of the steering angle is fixed to a predetermined angle. This predetermined angle is the smallest maximum value among set maximum values.

According to the second embodiment described above, the vehicle control system 100 controls the steering of the subject vehicle M on the basis of the first steering angle derived on the basis of the circular arc AR that has a tangent TL along the travelling direction of the subject vehicle M and passes through the gazing position OB and the position of the subject vehicle M, and accordingly, the subject vehicle M can be controlled such that it smoothly returns to the target locus while reducing the processing load.

### Third Embodiment

Hereinafter, a third embodiment will be described. A vehicle control system 100A according to the third embodiment derives a steering angle in a case in which manual driving is executed instead of deriving the steering angle in a case in which automatic driving is executed, which is different from the first embodiment. Hereinafter, relating differences will be focused in description.

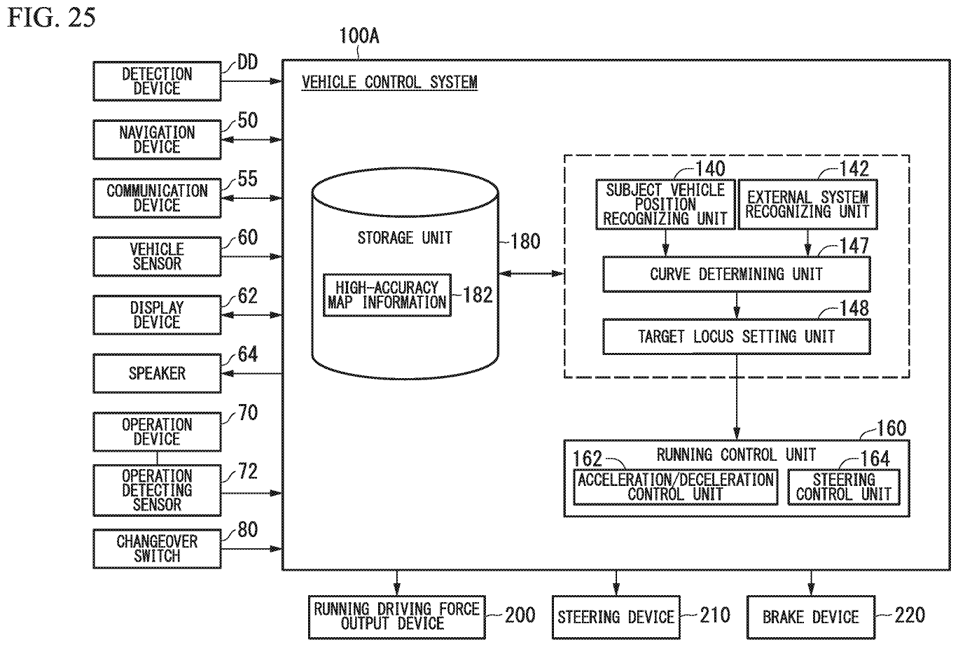

FIG. 25 is a diagram illustrating one example of the functional configuration of the vehicle control system 100A according to the third embodiment. The vehicle control system 100A includes a subject vehicle position recognizing unit 140, an external system recognizing unit 142, a curve determining unit 147, a target locus setting unit 148 (locus generating unit), a running control unit 160, and a storage unit 180 in which high-accuracy map information 182 is stored.

The curve determining unit 147 determines whether or not a road on which the subject vehicle M is running or is planned to run is a curved road on the basis of a result of a collation between a position of the subject vehicle M recognized by the subject vehicle position recognizing unit 140 and the high-accuracy map information 182.

In a case in which it is determined by the curve determining unit 147 that the subject vehicle M is running or is planned to run on a curved road, the target locus setting unit 148 generates a target locus on the curved road.

The target locus on the curved road, for example, is a locus in which center points on the curved road are connected.

The steering angle control unit 164 derives a steering angle on the basis of a target locus set by the target locus setting unit 148. In this embodiment, a timing at which the steering angle control unit 164 derives a steering angle will be described as being a case in which the position of the subject vehicle M is deviating from the target locus or a case in which the position of the subject vehicle M has deviated from the target locus, on a curved road. Here, the case in which the position is deviating or the case in which the position has deviated represents that a “predetermined position” such as the center of gravity of the subject vehicle M is separated away from a position in the target locus that is the closest to the “predetermined position” by a predetermined distance or more. In a case in which the position of the subject vehicle M is deviating from the target locus or a case in which the position has deviated from the target locus, the steering angle control unit 164 derives a steering angle such that the subject vehicle M runs on the target locus. The steering angle control unit 164 outputs the derived steering angle to the steering device 210, thereby assisting manual driving of a vehicle occupant. In addition, this assisting function may be controlled as being on or off by operating the changeover switch 80.

For example, in a case in which the position of the subject vehicle M deviates from the target locus due to an erroneous operation of a vehicle occupant in a state in which the assisting function is set to the on state, the subject vehicle M is controlled on the basis of the steering angle derived by the steering angle control unit 164. Accordingly, the subject vehicle M is controlled such that it runs on the target locus.

According to the third embodiment described above, in a case in which manual driving is executed, when the subject vehicle M deviates from the target locus, the vehicle control system 100A assists manual driving such that the subject vehicle M runs on the target locus, whereby the running stability of the subject vehicle M can be improved.

According to the embodiment described above, by including a position recognizing unit that recognizes a position of a vehicle, a locus generating unit that generates a future target locus of the vehicle, and a running control unit that sets a reference position on the target locus with respect to the position of the vehicle recognized by the position recognizing unit and controls steering of the vehicle on the basis of a circular arc that has a tangent along the travelling direction of the vehicle and passes through the reference position and the position of the vehicle, smoother steering control can be realized.

As above, while the embodiments of the present invention have been described using the embodiment, the present invention is not limited to such embodiment at all, and various modifications and substitutions may be made in a range not departing from the concept of the present invention.

### REFERENCE SIGNS LIST

20 Finder
30 Radar
40 Camera
DD Detection device
50 Navigation device
60 Vehicle sensor
62 Display device
100 Vehicle control system
110 Target lane determining unit
120 Automatic driving control unit
130 Automatic driving mode control unit
140 Subject vehicle position recognizing unit
142 External system recognizing unit
144 Action plan generating unit
146 Locus generating unit
146A Running mode determining unit
146B Locus candidate generating unit
146C Evaluation/selection unit
147 Curve determining unit
148 Target locus setting unit
150 Switching control unit
160 Running control unit
162 Acceleration/deceleration control unit
164 Steering angle control unit
170 Gazing position deriving unit
172 First steering angle deriving unit
174 Second steering angle deriving unit
176 Integration unit
180 Storage unit
200 Running driving force output device
210 Steering device
220 Brake device
M Subject vehicle

What is claim is:

1. A vehicle control system comprising:
a position recognizing unit configured to recognize a position of a vehicle;
a locus generating unit configured to generate a target locus of the vehicle; and
a running control unit configured to set a reference position with respect to the position of the vehicle recognized by the position recognizing unit on the target locus generated by the locus generating unit and control steering of the vehicle on the basis of a circular arc that has a tangent along a travelling direction of the vehicle and passes through the reference position and the position of the vehicle,
wherein the running control unit sets a position on the target locus of the vehicle in a case in which the vehicle is assumed to have run on the target locus for a predetermined time or over a predetermined distance from a position on the target locus that is the closest to the position of the vehicle recognized by the position recognizing unit as the reference position.

2. (canceled)

3. The vehicle control system according to claim 1,
wherein the running control unit:
derives a first index value based on the circular arc and a second index value for increasing control of steering of the vehicle as a deviation between the reference position and the position of the vehicle in a direction orthogonal to the travelling direction of the vehicle becomes larger; and
controls the steering of the vehicle on the basis of the first index value and the second index value.

4. The vehicle control system according to claim 3,
wherein, in a case in which the deviation is equal to or greater than a first predetermined value, the running control unit limits the control of the steering of the vehicle.

5. The vehicle control system according to claim 1,
wherein, in a case in which a curvature of the circular arc exceeds a second predetermined value, the running control unit limits the control of the steering of the vehicle.

6. The vehicle control system according to claim 3,
wherein the running control unit controls the steering of the vehicle on the basis of a position of the vehicle on the circular arc in a case in which the vehicle runs on the circular arc for a time shorter than the predetermined time used for acquiring the reference position and the position of the vehicle recognized by the position recognizing unit.

7. A vehicle control method using an in-vehicle computer, the vehicle control method comprising:
generating a future target locus of the vehicle;
setting a reference position with respect to a position of the vehicle recognized by a position recognizing unit recognizing the position of the vehicle on the generated future target locus and controlling steering of the vehicle on the basis of a circular arc that has a tangent along a travelling direction of the vehicle and passes through the reference position and the position of the vehicle; and
setting a position on the target locus of the vehicle in a case in which the vehicle is assumed to have run on the target locus for a predetermined time or over a predetermined distance from a position on the target locus that is the closest to the position of the vehicle recognized by the position recognizing unit as the reference position.

8. A vehicle control program causing an in-vehicle computer to execute:
generating a future target locus of the vehicle;
setting a reference position with respect to a position of the vehicle recognized by a position recognizing unit recognizing the position of the vehicle on the generated future target locus and controlling steering of the vehicle on the basis of a circular arc that has a tangent along a travelling direction of the vehicle and passes through the reference position and the position of the vehicle; and
setting a position on the target locus of the vehicle in a case in which the vehicle is assumed to have run on the target locus for a predetermined time or over a predetermined distance from a position on the target locus that is the closest to the position of the vehicle recognized by the position recognizing unit as the reference position.
